(19) United States
(12) Patent Application Publication
(10) Pub. No.: US 2006/0234697 A1
(43) Pub. Date: Oct. 19, 2006

(54) Diagnostics and self-healing in a wireless communications device based on peer-to-peer signaling and emulation

(75) Inventors: Juan C. Fernandez, Boca Raton, FL (US); David J. Hayes, Lake Worth, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/017,316

(22) Filed: Dec. 20, 2004

(51) Int. Cl. H04Q 7/20

(52) U.S. Cl. 455/425

(57) ABSTRACT

A method (400) of responding to a signaling problem at a communication device (102) includes identifying (404, 414) another communication device (118) to act as a peer of the communication device if a first signal quality measurement of a wide-area signal received at the communication device is less than a predetermined threshold. The method includes generating (416) a second signal quality measurement that is conveyed over a peer-to-peer connection (120) between the communication device (102) and the peer. The method further includes determining (418), based upon the second signal quality measurement, whether or not the source of the signaling problem is a fault in the communication device (102). The method can further include generating (423) a third signal quality measurement that can be compared to the first signal quality measurement for determining a source of the signaling problem.

### BACKGROUND

1. Field of the Invention

The present invention is related to the field of wireless communications devices and networks, and, more particularly, to the diagnosis and correction of faults in a wireless communications device.

2. Description of the Related Art

The field of wireless communications continues to be among the most rapidly evolving areas of modern technology. An increasing number of traditional communication and computing devices now possess new-found mobility based on emerging wireless communication capabilities. This expanding world of wireless devices includes not only the more traditional cellular phone but newer additions such as the wireless laptop computer, the personal digital assistant (PDA), and a host of other devices like wireless sensors and tags. Evidence of the continued and rapid evolution of wireless communications technology can be seen, for example, in the development of so-called third-generation (3G) cellular technology and the emergence of wireless local area networking (WLAN) technologies.

Notwithstanding this tremendous advancement, wireless communications still face challenges. One of the most persistent challenges stems from the fact that wireless communications involve the transmission of radio frequency (RF) signals; that is, transmission of electromagnetic (em) waves within the radio frequency range. Even under the best of conditions, communication via RF signals is a challenge since free-space attenuation reduces the strength of an RF signal at a rate proportional to the square of the distance traversed by the signal. Further attenuation can also occur due to the RF signal being blocked by various obstacles such as building, trees, and even particles within the atmosphere.

RF signals are also subject to reflection, which leads to multi-path or channel fading. The reflection of components of a signal causes the reflected components to arrive at a receiver after some time delay relative to other components of the same signal that follow a direct or shorter reflected path. This can introduce random phase changes so that similar signals, offset in time from one another, tend to add or subtract depending on their relative phase differences. The end result of multi-path or channel fading is further signal degradation.

These inherent problems in wireless communication can make it difficult to discern whether a signal problem at a communication device is due to a factor such as multi-path fading or a problem with the communication device itself. Moreover, since wide-area communications typically depend on devices communicating via interconnections effected by cellular and other networks, another potential source of signaling problems is faults in the infrastructure of the network that provides interconnections between different devices. The problem of identifying the source of a signal problem is further exacerbated by the increasing use of multiple protocols for carrying out local-area communications. These include such protocols as MotoTalk, Bluetooth, and IEEE 802.11. In this latter context, even if it is determined that the source of a signal problem lies with the communication device, it may be difficult to discern whether the problem is uniquely related to a specific one of the multiple protocols for which the device may be configured.

As yet, conventional devices and methods still lack an effective and efficient way to determine the source of a signaling problem at a communication device. Accordingly, because poor signal quality can stem from a number of different sources—including memory corruption, component failures, network problems and multi-path fading—it is often difficult to diagnose the cause of a signaling problem. It follows, moreover, that whereas conventional devices and techniques typically lack an effective capability for correctly diagnosing the source of a signaling problem, they typically also lack an effective capability for prescribing an appropriate remedy for the signaling problem.

### SUMMARY OF THE INVENTION

The present invention provides a system and methods for responding to a signaling problem at a wireless communication device. Moreover, the present invention also provides a system and methods for effecting a self-correction of faults discovered to be the source of a signaling problem in a communication device.

According to one embodiment, a method of responding to a signaling problem at a communication device can include identifying a peer of the communication device if a first signal quality measurement is less than a predetermined threshold. The first signal quality measurement can be based on a wide-area signal between the communication device and a node of a wide-area communications network. The method also can include generating a second signal quality measurement that is conveyed over a peer-to-peer connection between the communication device and the peer. The method further can include determining whether or not the source of the signaling problem is a fault in the communication device, the determination being based upon the second signal quality measurement.

According to one embodiment, the second signal quality measurement can be based upon a quality of a peer-to-peer signal between the communication device and the peer. According to another embodiment, the second signal quality measurement can be determined when the peer emulates an infrastructure of the wide-area communications network during the transmission of the peer-to-peer signal. According to still another embodiment, the second signal quality measurement can be based upon a quality of a wide-area signal monitored by the peer and conveyed between the communication device and a wide-area communications network node. According to yet another embodiment, the second signal quality measurement can correspond to a quality of a wide-area signal transmission between the peer and a wide-area communications network node.

A method of responding to a signaling problem at a communication device, according to an alternative embodiment of the invention, can include identifying a peer of the communication device if a first signal quality measurement of a wide-area signal received at the communication device is less than a predetermined threshold. The method also can include receiving at the communication device a second signal quality measurement that is based upon a wide-area signal received at the peer. The method further can include establishing a peer-to-peer connection between the communication device and the peer if the first signal quality measurement differs from the second signal quality measurement by a predetermined amount.

The method also can include generating a third signal quality measurement based upon at least one signal transmission carried over the peer-to-peer connection, the signal transmission being conveyed while the communication device and/or the peer emulate a wide-area communication network infrastructure. The method can further include determining whether or not the source of the signaling problem is a fault in the communication device. The determination can be based upon a comparison of the first and third signal quality measurements.

A system for handling a signaling problem at a communication device, according to another embodiment, can include a peer identification module for identifying a peer of the communication device in response to the signaling problem. The system also can include a problem determination module for determining whether or not the source of the signaling problem is a fault in the communication device. The determination can be based upon a signal quality measurement carried over a peer-to-peer connection established between the communication device and the peer.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a communication network, which includes a communication device that is operatively linked to a system for handling signaling problems at the communication device according to one embodiment of the present invention.

FIG. 2 is a schematic diagram of components included in the system shown in FIG. 1.

FIG. 3 is a schematic diagram of a system for handling signaling problems at a communication device according to another embodiment of the present invention.

FIG. 4 is flowchart illustrative of a method according to yet another embodiment of the invention.

FIG. 5 is a flowchart illustrative of a different method according to still another embodiment of the invention.

### DETAILED DESCRIPTION OF THE INVENTION

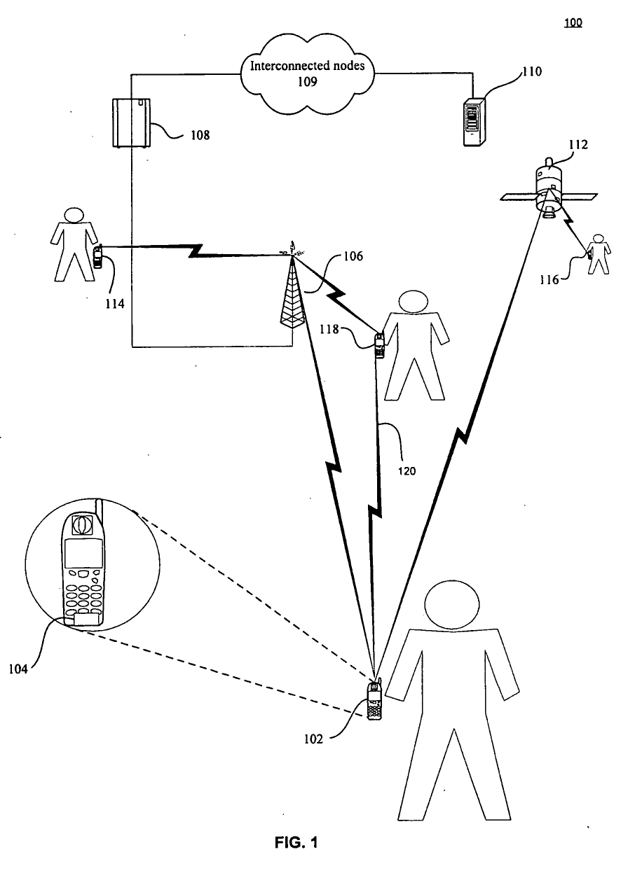

FIG. 1 is a schematic diagram of an exemplary communications network 100 that illustratively includes a communication device 102 operatively linked to a system 104 that, according to one embodiment of the present invention, is responsive to signaling problems detected at the communication device. The components of the exemplary communications network 100 can be characterized as communications network nodes and illustratively include a cellular tower 106, a switching element 108 connected to the cellular tower, a collection of one or more interconnected core nodes 109 connected to the switching element, and a server 110 linked to the other components through the interconnected core nodes. The exemplary communications network 100 also illustratively includes a communications satellite 112, such as a low earth orbit (LEO) or medium earth orbit (MEO) satellite for further facilitating wide-area communications with the communication device 102.

As will be readily apparent from the ensuing discussion, the system 104 described herein can also be employed in various other communications networks whose infrastructure encompasses some or all of the same illustrated components, as well as different ones. Likewise the system 104 can be employed with a variety of different types of communication devices that have the capabilities for carrying out both wide-area communications via interconnections through the communications network 100 as well as peer-to-peer communications that do not rely on interconnections through the communications network.

Illustratively, the communication device 102 operatively linked to the system 104 is a cellular phone. Alternately, though, the communication device 102 can be a computing device, such as personal computer (PC) or laptop terminal having wireless communication capabilities. The communication device 102, alternatively, can be a personal digital assistant (PDA). Indeed, as will be apparent from the discussion herein, the communication device can be virtually any type of electronic device having the capabilities for carrying out both wide-area and alternate wireless communications, including communications via a peer-to-peer connection.

The communication device 102, as illustrated, utilizes the infrastructure of the exemplary communications network 100 to transmit and receive wide area communications signals to and from another communication device 114 via the cellular tower 106, to and from yet another communication device 116 via the communication satellite 112, as well as to and from the server 110 via the communication linkage provided by the cellular tower, switching element 108, and interconnected core nodes 109. Again, though, these communication linkages are merely illustrative of various ones that can be employed using different network architectures and infrastructures for effecting wide-area communications.

The wide-area communications effected with the communication device 102 can include a variety of applications. These include wireless voice communication as well as wireless messaging. With appropriate software-based encryption, the wide-area communications can even include private data communications across the shared infrastructure of the exemplary communications network 100.

In addition to wide-area communications, the communication device 102 is also able to effect local-area communications with yet another communication device 118 via a peer-to-peer connection. The peer-to-peer connection enables the communication device 102 to transmit and/or receive transmission signals to and/or from another communication device without using an intermediary node or nodes. The peer-to-peer connection, more particularly, is a non-cellular communication mode. The communication mode can be provided, for example, by MotoTalk, a proprietary system by Motorola, Inc., of Schaumburg, Ill. Other peer-to-peer protocols include the personal area network protocol denoted as Bluetooth, and various wireless network protocols such as the IEEE 802.11.

As already noted, the system 104 handles signaling problems that occur at the communication device 102. A signaling problem arises in connection with signal transmissions involving the communication device 102 and at least one other communication device. More particularly, a signaling problem denotes that the communication device 102 is unable to adequately receive a signal from at least one other communication device and/or the communication device is unable to effectively transmit to another communication device. A signaling problem can stem from a fault with the communication device 102 itself. More particularly, the fault can be with one or more circuit components and/or one or more portions of software code that, depending on the type of the particular device, comprise the communication device 102. Moreover, a circuit-related and/or software-related fault can be a fault common to communication devices that contain the same or similar components as the communication device 102, or, alternatively, the fault can be unique to the communication device. A unique fault in the circuitry or software of the communication device 102 could result, for example, from a manufacturing defect unique to the individual device or be the result of damage to the components of the device subsequent to manufacturing.

Alternatively, the source of a signaling problem can be a fault—again, a fault in hardwired, dedicated circuitry and/or software code—in the infrastructure of a communications network over which communication signals are conveyed to and/or from the communication device 102. For example, in the context of the exemplary communications network 100, a circuitry-related and/or software-related fault at any one of the cellular communication tower 106, switching element 108, interconnected core nodes 109 linked to the server 110, or communication satellite 112 could result in a signaling problem at the communication device 102. In particular, a fault in the infrastructure of a communication network can adversely affect wide-area communication signal transmissions between the communication device 102 and any other device with which the communication device is attempting to communicate.

Still another potential source of signaling problems at the communication device 102 is the particular environment in which the communication device is operated. First, since the communication device 102 is a wireless device transmitting and receiving RF signals, free-space attenuation reduces the strength of a signal at a rate proportional to the square of the distance traversed by the signal even under the most favorable conditions. Further attenuation can also occur due to the RF signal being blocked by various obstacles such as building, trees, and even particles within the atmosphere. The RF signals are also subject to reflection, which can lead to multi-path or channel fading. The reflection of components of a signal causes the reflected signal components to arrive at the communication device 102 after some time delay relative to other components of the same signal that follow a direct or shorter reflected path. As will be readily appreciated by one or ordinary skill in the art, reflection thus introduces random phase changes such that similar signals, offset in time from one another, tend to add or subtract depending on their relative phase differences. The end result of multi-path or channel fading is further signal degradation.

Signal blocking and channel fading are distinct from the other two potential sources of signaling problems in that the former are functions of time and location of the communication device 102, not faults in either the communication device or the infrastructure of a network such as the exemplary communication network 100. It is a function of the system 104, according to one embodiment of the present invention, to respond to a signal problem at the communication device 102 by identifying from which of the potential sources the problem likely stems.

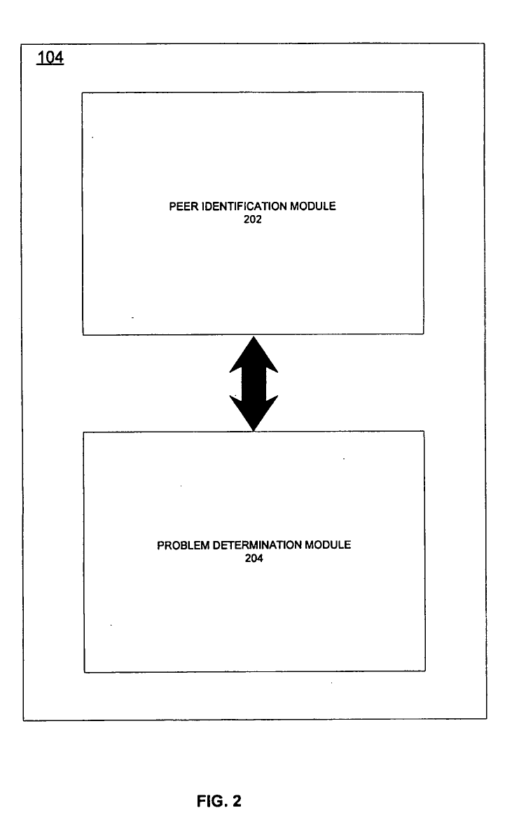

Referring additionally to FIG. 2, the system 104 illustratively includes a peer identification module 202 for identifying a peer of the communication device in response to the signaling problem, as described herein. The system 104 also illustratively includes a problem determination module 204 communicatively linked to the peer identification module 202 for determining whether or not the source of the signaling problem is a fault in the communication device 102, as also described herein.

A signaling problem at the communication device 102 can be made apparent, for example, by comparing the quality of a wide-area signal received by the communication device to a predetermined benchmark. An example of a signal quality measurement is the signal-to-noise ratio (SNR). A figure of merit used in baseband and other communication systems, the SNR is determined by dividing the measured power of an information-carrying signal by the measured power of noise in the system. The SNR thus can be determined and then compared to a predetermined threshold selected to reflect the possibility of a signaling problem. If the SNR is less than a desired threshold level, the information-carrying signal is likely so degraded as to be unusable by the communication device 102. As will be readily appreciated by one of ordinary skill in the art, various other measurements can alternately be used to measure signal quality. Other signal quality measurements include, but are not limited to, a bit error rate (BER) and a data-packet error rate. In the context of the discussion herein, the measurement of the quality of the wide-area signal received and/or transmitted by the communication device constitutes a first signal quality measurement.

Regardless of the particular signal quality measurement employed in indicating a signaling problem at the communication device 102, the peer identification module 202 responds to the signaling problem by identifying another entity that can and will act as a peer of the communication device. For example, the peer identification module 202 can use a wireless scanning signal that identifies an active communication device that is in the vicinity and that is able to serve as a peer of the communication device 102. According to one embodiment, once the peer is identified, a peer-to-peer connection 120 is established between the communication device 102 and the peer. The peer identification module 202 then elicits from the peer a signal quality measurement constituting a second signal quality measurement. The second signal quality measurement can be, for example, an SNR, BER, or other measure of signal quality. The second signal quality measurement is conveyed over the peer-to-peer connection between the communication device 102 and the peer.

The second signal quality measurement, according to one embodiment, corresponds to the quality of a signal conveyed over the peer-to-peer connection 120 between the communication device 102 and the peer. Accordingly, if the communication device 102 experiences a problem receiving or transmitting a wide-area signal over the communications network 100, the system 104 can respond by establishing a peer-to-peer connection with a peer and ascertaining whether the same problem pertains with respect to the peer. The determination can be made on the basis of the second signal quality measurement, which is conveyed over the peer-to-peer connection 120 and is itself based on the quality of peer-to-peer signaling between the communication device and the peer. If the quality of the signal conveyed over the peer-to-peer connection is adequate, this suggests that the signaling problem does not stem from a fault in the communication device 102.

According to another embodiment, the second signal quality measurement corresponds to the quality of one or more signals conveyed over the peer-to-peer connection 120 as the peer emulates the infrastructure of the communications network 100. Alternately, the communication device 102 itself, or both the communication device and the peer, can emulate the infrastructure of the communications network 100. The emulation of the infrastructure allows the communication device 102 and/or peer to mimic the function of a handset as the other duplicates the function of the infrastructure. By duplicating the functions of the infrastructure, the communication device 102 and peer appear to operatively behave like the infrastructure, just as a computer behaves like another computer when it emulates the other computer by accepting the same data and executing the same programs, for example.

By effecting an emulation of the network infrastructure via the peer-to-peer connection 120, the communication device 102 and its peer are able to exercise the complete transceiver chain just as though the connection were carried by the network itself, even though, in fact, no aspect of the network infrastructure is involved in the communication. For example, if the communication device 102 and peer utilize iDEN technology, the connection can be characterized as a “pseudo” iDEN link. The emulation enables the problem determination module 204 to collect test correlation results reflecting the performance of circuitry and software components.

According to still another embodiment, the second signal quality measurement can correspond to the quality of another wide-area signal between the communication device 102 and one other of the nodes of the communications network 100. The second signal quality measurement is determined by the peer monitoring the signals and conveying the second signal quality measurement over the peer-to-peer connection between the communication device 102 and the peer.

According to yet another embodiment, the second signal quality measurement reflects the quality of a wide-area signal received at the peer and conveyed over the same communications network as the problematic wide-area signal on which the first signal quality measurement is based. The problem determination module 204 illustratively compares the second signal quality measurement elicited from the peer with the quality of the problematic wide-area signal received at the communication device 102. If the respective signal quality measurements are sufficiently close to one another, their difference will be less than a predetermined amount, the predetermined amount reflecting the closeness that is needed between the respective signal quality measurements in order to consider the measurements sufficiently similar to one another. Since the peer, by the manner of its selection, is in close proximity to the communication device 102, an acceptable closeness in the respective signal quality measurements can be taken as an indication that the similarly situated devices are experiencing wide-area signal transmissions at relatively the same levels of quality. This accordingly suggests that the signaling problem experienced at the communication device 102 is likely due to network factors, not a fault in the communication device itself.

Conversely, if there is a substantial difference between the two signal quality measurements, this suggests that there is a problem with the communication device 102 itself. Accordingly, further diagnostic action is warranted. If the second signal quality measurement is based on the quality of a wide-area signal involving the peer and the communications network 100, then the system 104 can first request the signal quality measurement from a peer identified by the peer identification 202 before a peer-to-peer connecton is established between the communication device 102 and the peer. If this procedure is implemented by the system, the peer-to-peer connection need only be established after, and only if, a comparison of the first and second signal quality measurements indicates that further diagnostic action is warranted. If such action is warranted, the problem determination module 204 responds by causing the peer-to-peer connection 120 to be established between the communication device 102 and its peer.

A third signal quality measurement can then be determined on the basis of the signal quality of the one or more signals transmitted over the peer-to-peer connection 120. Again, the communication device 102 and/or its peer can emulate the network infrastructure. The third signal quality measument, can be determined and compared to the signal quality of the wide-area communication signals received at the communication device. If the measurements are dissimilar, then it can be inferred that the signaling problem experienced by the communication device 102 is due to signal blocking and/or channel fading, which as described above are functions of the time and location of the communication device 102 during the signal transmission rather than a fault in the communication device itself. Conversely, though, a similarity in the respective measurements suggests that the signaling problem is due to fault in the communication device.

According to still another embodiment of the present invention, the peer identification module 202 initially establishes a buddy list of potential peer devices even before a signaling problem is encountered at the communication device 102. The buddy list provides a list of communication devices, each of which defines a trusted entity that can be contacted if the communication device 102 encounters a signaling problem. In the event of Such a signaling problem, the identification establishes contact with a buddy that is selected from the buddy list and that is within the vicinity of the communication device 102. In particular, a buddy is within the vicinity if the buddy can be contacted by the communication device through a peer-to-peer connection 120. The connection, moreover, can be established according to one or more communication protocols. These include the MotoTalk, Bluetooth, and IEEE 802.11 protocols. If the connection is established, the selected buddy serves as the peer of the communication device 102.

According to this same embodiment, if the peer identification module 202 is unable to establish a peer-to-peer wireless connection with a communication device listed among the buddies of the communication device 102, then, in the alternative the peer identification module reverts to utilizing a wireless signal scan to identify a potential peer from among other active communication devices in the vicinity of the communication device 102. Once so identified by the peer identification module 202, the other communication device is contacted and the peer identification module requests permission to retrieve from the other communication device signal quality information such as an SNR or BER as described above.

According to yet another embodiment of the present invention, if it is determined that the signaling problem is due to a fault in the communication device, the problem determination module 204 responds by initiating the transmission of one or more test signals over the peer-to-peer wireless connection 120 established between the communication device 102 and its peer. Different test signals can be initiated seriatim by the problem determination module 204 with different wireless transports enabled at the communication device 102 and the peer in order to distinguish between common and unique faults, whether circuitry-related or software-related.

For example, the problem determination module 204 can initiate transmission of a test signal over the peer-to-peer connection 120 with both the communication device 102 and its peer enabling the MotoTalk wireless transport. Subsequently, for example, the problem determination module 204 can initiate transmission of a test signal over the peer-to-peer connection 120 with both the communication device 102 and its peer enabling the Bluetooth wireless transport. Additionally, the problem determination module 204 can initiate transmission over the peer-to-peer connection with both the communication device 102 and its peer enabling a WLAN wireless transport, such as the IEEE 802.11. The signaling performances with the different wireless transports enabled then can be compared with one another. If the signaling performances based on test signals with different wireless transports enabled are similar, this similarity suggest a common circuit- and/or software-related fault at the communication device 102. Conversely, if the results differ, a unique circuit- and/or software-related fault specifically related to a particular transport is suggested.

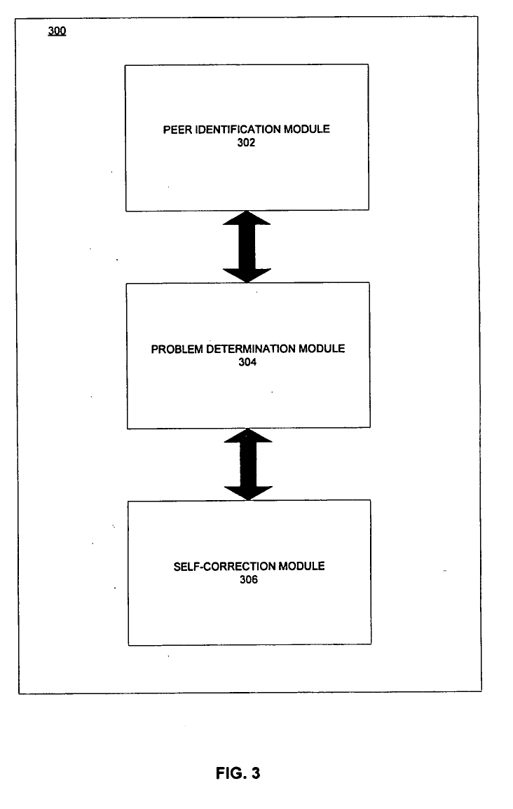

As illustrated in FIG. 3, a system 300 according to yet another embodiment includes a self-correction module 306 in addition to a peer identification module 302 and a problem determination module 304. The peer identification module 302, in response to a signaling problem at a communication device, identifies a peer as described above. Again, the signaling problem can be a degraded wide-area communications signal received by the communication device. As also described above, once the peer is identified, the problem determination module 304 determines whether or not the signaling problem at a communication device stems from a fault in the communication device.

If it is determined that the source of a signaling problem is a fault at the communication device and the nature of the problem is identified, the self-correction module 306 can initiate a self-correct operation. The self-correction operation can include a “unit reset,” according to which the communication device is reset. An alternative self-correction operation can be the download of software patch provided to the communication device via a wireless transmission. According to still another embodiment, a self-correction operation can be the download of a software upgrade likewise provided to the communication via a wireless transmission.

Each of the various modules described can be implemented in dedicated hardwired circuitry, as software-based processing instructions configured to run, for example, on a processor contained in the communication device, or as a combination of dedicated circuitry and software-based processing instructions. Moreover, although a system for responding to and handling a signaling problem at a communication device has been illustratively shown as contained within the communication device, it should be appreciated that one or more modules comprising such a system can reside on a separate device remote from the communication device. For example, one or more of the modules described could reside on a server that is communicatively linked with the communication device to effect one or more of the various operations described herein.

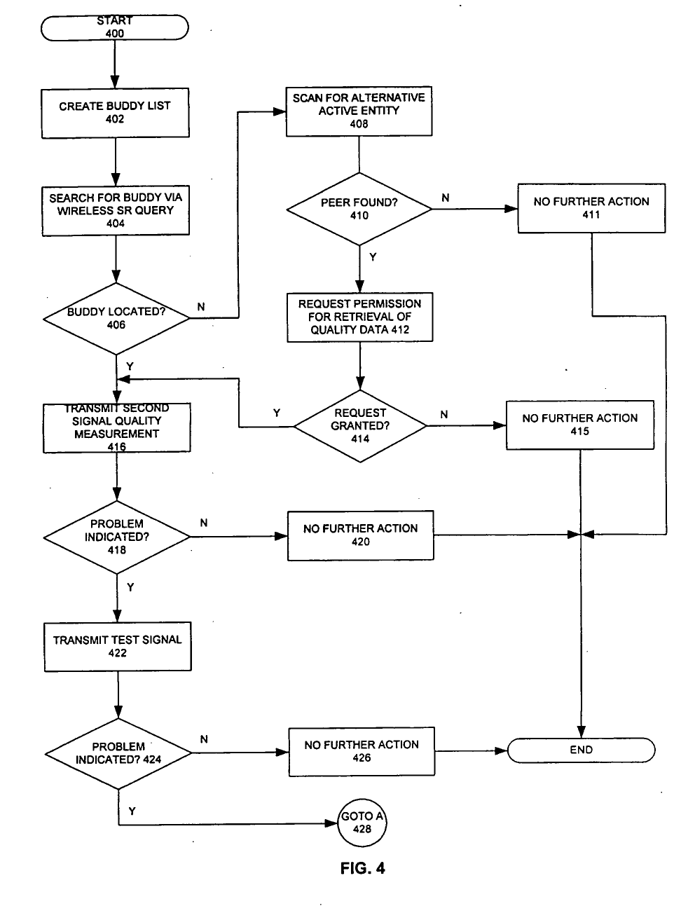

A method 400 in accordance with an embodiment of the invention is illustrated by the flowchart provided in FIG. 4. The method 400 provides a response to signaling problems that may occur at a communications device. According to one embodiment, the method 400 begins even before a signaling problem is encountered, with the generation of a buddy list at step 402. The buddy list can be used to identify other communications devices that can be expected to provide a trusted communication resource for dealing with a signaling problem. A signaling problem occurs, for example, if a wide-area signal between the communication device 102 and a node of a wide-area communications network 100 has a signaling quality that fails to meet a predetermined standard, such as the receipt of a signal having an SNR whose value is less than a predetermined level. Again, the SNR or other signal quality measurement based upon the quality of a signal at the communication device 102 constitutes a first signal quality measurement.

As illustrated, the identification of a peer in response to a signaling problem includes, at step 404, a search for one of the buddies from the buddy list generated in the preceding step. The search is illustratively carried out with a wireless signaling inquiry. If it is determined at step 406 that no active buddy can be identified to serve as a peer, then the process of identifying a peer continues at step 408 with a search for an active entity within the vicinity that can serve as a peer. If it is determined step 410 that an active entity can be located, then at step 412 permission is requested from the entity for retrieving a signal quality measurement or other signaling quality data. The process of identifying a peer of the communication device 102 in response to a signaling problem concludes at step 414 where a determination is made as to whether permission is granted.

It is worth noting at this juncture that an alternative embodiment of handling signaling problems at a communication device 102 foregoes the steps pertaining to the creation and subsequent search of a buddy list. According to this alternative embodiment, the identification of a peer of the communication device 102 in response to a signaling problem begins with a wireless signaling inquiry to locate an active entity within the vicinity. When identified, the entity is contacted and permission is requested to receive from the entity signaling quality data, such as an SNR or BER based upon a wide-area signal received at the entity. The steps described in the following paragraphs occur whether the peer is an entity that consents to serve as a peer or is a buddy selected from an earlier-generated buddy list. In either event, if neither a buddy nor an entity in the vicinity that consents to act as a peer can be located, no further action is taken and the procedure stops at either steps 411 or 415 as shown in FIG. 4

As further illustrated in FIG. 4, if another communication device 118 that can and will act as a peer is located, then a second signal quality measurement is generated, the second signal quality measurement being conveyed at step 416 to the communication device 102 over a peer-to-peer connection 120 that is established between the communication device and the peer. The transmitted signal quality measurement again constitutes a second signal quality measurement. The second signal quality measurement, as described herein, provides a basis for determining at step 418 whether or not the source of the signaling problem is a fault in the communication device 102.

According to one embodiment, the second signal quality measurement corresponds to the quality of one or more peer-to-peer signals between the communication device 120 and the peer. If the second signal quality measurement is adequate, this indicates it is unlikely that the source of the signaling problem is a fault in the communication device 102. According to yet another embodiment the second signal measurement is determined on the basis of one or more peer-to-peer signals conveyed as the peer and/or the communication device emulate the infrastructure of the communications network 100 so that a determination can more readily be made as to whether or not the signaling problem stems from a fault in the communications network. According to still another embodiment, the second signal quality measurement can be based upon the quality of a wide-area signal between the communication device and a node of the communications network 100, the wide-area signal being monitored by the peer to determine whether or not there is a problem at the communication device 102.

According to yet another embodiment, the second signal quality measurement reflects the quality of a wide-area signal between the peer and a node of the communications network 100 over which the problematic signal involving the communication device 102 was transmitted. The second signal quality measurement is transmitted over the peer-to-peer connection between the peer and the communication device 102. Accoringly, at step 418, the second signal quality measurement is compared with the first signal quality measurement, which as described above reflects the quality of a wide-area signal received at the communication device 102. If the first and second signal quality measurements are equal or sufficiently similar, the procedure terminates at step 420 since the similarity of results suggests that a wide-area network is the source of the signaling problem, not a fault in the communication device 102. If, however, the first and second signal quality measurements are not similar, then further diagnostic action is warranted.

Regardless of the form that the second signal quality measurement takes, once a determination is made at step 418 that there is at least the possibility that a signaling problem stems from a fault in the communication device 102, additional steps can be taken to further diagnose the source or nature of the signaling problem. Thus, according to another embodiment, the method 400 continues at step 422 with the conveyance of a test signal over a peer-to-peer connection between the communication device 102 and the peer. A third signal quality measurement is generated at step 423 based upon the signal transmission via the peer-to-peer connection 120. The quality of the signal, moreover, can be measured as one or both the communication device 102 and peer emulate the infrastructure of the communications network 100.

A determination based on this third signal quality measurement is made at step 424 as to whether or not the quality of the signal conveyed over the peer-to-peer connection is significantly different from the quality of the wide-area signal received at the communication device 102. More particularly, the third signal quality measurement is compared to the first signal quality measurement to determine whether there exists a disparity in quality between transmissions via the peer-to-peer connection 120 and those conveyed via a wide-area network.

If it is determined based upon the second signal quality measurement, as described above, or, alternately, on the comparison of first and third signal quality measurements, that the wide-area and peer-to-peer signal qualities are not significantly different, this suggests that the quality of the wide-area signal is the result of a factor such as signal blocking and/or channel fading, in which event no further action is needed and the procedure ends at step 426. If the results are significantly different, though, this suggests that the signaling problem may stem from a fault in the communication device 102 and, therefore, further action is warranted. If further action is warranted, then, according to another embodiment, this leads to the GOTO statement at 428.

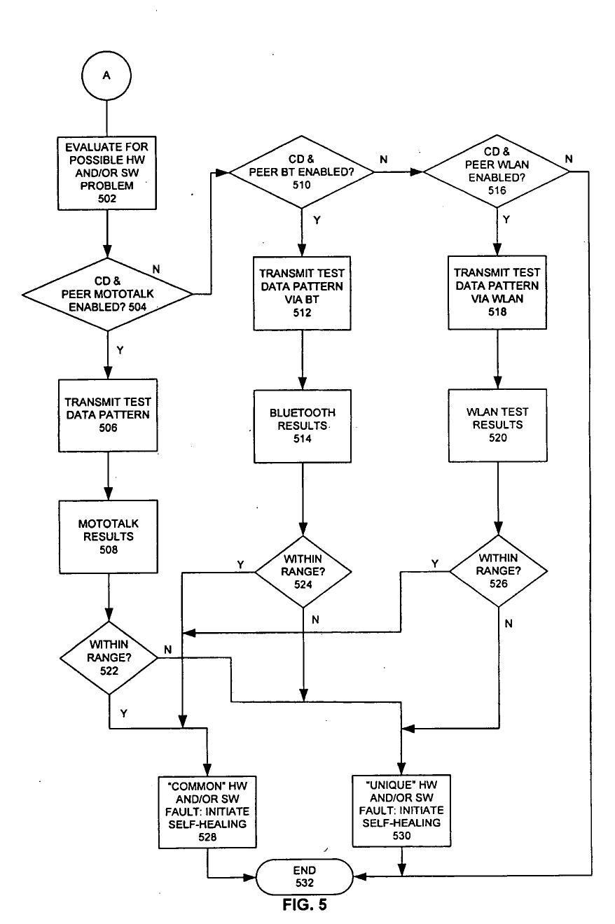

FIG. 5 provides a flowchart according to another embodiment that extends the procedure illustrated in the previous figure. The extension according to this alternate embodiment provides an additional result, namely, identifying the type of fault in the communication device that results in a signaling problem. Accordingly, beginning after the GOTO statement of the previous procedure, the procedure continues at step 502 in determining whether the signaling problem stems from a particular type of fault. A determination is made at step 504 as to whether the MotoTalk transport mode is enabled at the communication device and its peer. If so, signal testing in the context of the enabled MotoTalk transport is performed at step 506. Test results which can be stored in a memory are collected at step 508.

Similarly, at step 510 a determination is made as to whether the Bluetooth transport mode is enabled at the communication device and its peer, and, if so, at step 512 signal testing in the context of the enabled Bluetooth transport is performed and corresponding test results collected at step 514. Likewise, at step 516 a determination is made as to whether a WLAN transport mode such as IEEE 802.11 is enabled at the communication device and its peer. If so, at step 518 signal testing in the context of the enabled WLAN transport mode is performed and corresponding test results are collected at step 520. The test results are assessed at steps 522, 524, and 526. If the differences between the respective results are within an acceptable range, this suggests a common circuit- and/or software-related fault at the communication device, a determination of which is made at step 528 as shown. Otherwise, if the respective results are significantly different, then this suggests that a unique circuit- and/or software-related fault exists, this latter determination being made at step 530. The procedure concludes then at step 532.

As already noted, certain features of embodiments of the present invention can be realized in hardware, software, or a combination of hardware and software. Accordingly, embodiments can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

Embodiments also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

That claimed is:

1. A method of responding to a signaling problem at a communication device, the method comprising the steps of:
identifying a peer of the communication device if a first signal quality measurement based on a wide-area signal between the communication device and a node of a wide-area communications network is less than a first predetermined threshold;
generating a second signal quality measurement that is conveyed over a peer-to-peer connection between the communication device and the peer; and
determining based upon the second signal quality measurement whether or not the source of the signaling problem is a fault in the communication device.

2. The method of claim 1, wherein the second signal quality measurement is based upon a quality of a peer-to-peer signal between the communication device and the peer.

3. The method of claim 2, wherein at least one of the communication device and the peer emulates an infrastructure of the wide-area communications network during the transmission of the peer-to-peer signal.

4. The method of claim 1, wherein the wide-area signal comprises a first wide-area signal and wherein the second signal quality measurement is based upon a quality of a second wide-area signal monitored by the peer and conveyed between the communication device and the wide-area communications network node.

5. The method of claim 1, wherein the second signal quality measurement corresponds to a quality of a wide-area signal transmission between the peer and the wide-area communications network node.

6. The method of claim 1, further comprising identifying a type of fault if it is determined that there is a fault in the communication device.

7. The method of claim 6, wherein the step of identifying the type of fault comprises transmitting a test signal over the peer-to-peer connection.

8. The method of claim 1, further comprising performing a communication device self-correction if it is determined that there is a fault in the communication device.

9. The method of claim 8, wherein the communication device self-correction comprises at least one of a unit reset, a wireless software patch download, a wireless software upgrade.

10. The method of claim 8, wherein the step of performing the communication device self-correction is automatically initiated by the communication device.

11. The method of claim 1, further comprising generating a buddy list indicating at least one buddy communication device; and wherein identifying the peer comprises selecting a buddy communication device from the buddy list.

12. A method of responding to a signaling problem at a communication device, the method comprising the steps of:
identifying a peer of the communication device if a first signal quality measurement of a wide-area signal received at the communication device is less than a predetermined threshold;
receiving at the communication device a second signal quality measurement, the second signal quality measurement based upon a wide-area signal received at the peer;
establishing a peer-to-peer connection between the communication device and the peer if the first signal quality measurement differs from the second signal quality measurement by a predetermined amount;
generating a third signal quality measurement based upon at least one short-range signal transmission carried over the peer-to-peer connection while at least one of the communication device and the peer emulates a wide-area communication network infrastructure; and
determining whether or not the source of the signaling problem is a fault in the communication device, the determination being based upon a comparison of the first and third signal quality measurements.

13. The method of claim 12, further comprising identifying a type of fault if it is determined that there is a fault in the communication device based upon transmission of a test signal over the peer-to-peer connection.

14. The method of claim 12, further comprising performing a communication device self-connection if it is determined that there is a fault in the communication device.

15. The method of claim 14, wherein the communication device self-correction comprises at least one of a unit reset, a wireless software patch download, a wireless software upgrade.

16. A system for handling a signaling problem at a communication device, the system comprising:
a peer identification module for identifying a peer of the communication device if a first signal quality measurement based on a wide-area signal between the communication device and a node of a wide-area communications network is less than a first predetermined threshold; and
a problem determination module for determining whether or not the source of the signaling problem is a fault in the communication device, the determination being made based upon a second signal quality measurement that is conveyed over a peer-to-peer connection between the communication device and the peer.

17. The system of claim 16, wherein the second signal quality measurement is based upon a quality of at least one of a peer-to-peer signal between the communication device and the peer, a wide-area signal monitored by the peer, and a wide-area signal transmission between the peer and the wide-area communications network node.

18. The system of claim 16, wherein, in response to a determination that there is a fault, the problem determination module further determines a type of the fault based upon transmission of at least one test signal over the peer-to-peer connection.

19. The system of claim 16, further comprising a self-correction module residing on the communication device for causing the communication device to perform a self-correction operation if it is determined that there is a fault in the communication device.

20. The system of claim 19, wherein the self-correction operation comprises at least one of a unit reset, a wireless software patch download, a wireless software upgrade.
